(19) United States
(12) Patent Application Publication
(10) Pub. No.: US 2009/0094971 A1
(43) Pub. Date: Apr. 16, 2009

(54) SYSTEM AND APPARATUS TO SYNCHRONIZE A PLURALITY OF HYDRAULICALLY ACTUATED COMPONENTS

(76) Inventors: Roy J. Dantas, Scarborough (CA); Jack M. Nobre, Brampton (CA); Matt Holmes, Dundas (CA)

Correspondence Address: BERESKIN AND PARR, 40 KING STREET WEST, BOX 401, TORONTO, ON, M5H 3Y2, CA

(21) Appl. No.: 12/235,275

(22) Filed: Sep. 22, 2008

Related U.S. Application Data
(60) Provisional application No. 60/974,355, filed on Sep. 21, 2007.

(51) Int. Cl. F16D 31/00; F16K 11/00

(52) U.S. Cl. 60/327; 137/861

(57) ABSTRACT

Applicants' teachings relate to a system and apparatus to synchronize a plurality of hydraulically actuated components. In various embodiments of applicants' teachings, for example, but not limited to, in an automotive vehicle lift rack, a system and apparatus are disclosed to synchronize the platforms of the lift so that they are coplanar, and in some embodiments, maintained in a generally level configuration. The system comprises a hydraulic fluid reservoir, and at least two hydraulically actuated components in fluid communication by a first fluid flow path with the hydraulic fluid reservoir. Moreover, in accordance with various embodiments of applicants' teachings, a discharge valve is provided, the discharge valve in selective fluid communication by a second fluid flow path with a hydraulic fluid reservoir and the hydraulically actuated components. Moreover, in accordance with various embodiments of applicants' teachings, the system further comprises a control unit responsive to relative displacement of the at least two hydraulically actuated components. The control unit to selectively control the discharge valve, so that in response to the relative displacement of the at least two hydraulically actuated components the control unit activates the discharge valve to allow at least a portion of the hydraulic fluid to flow away by the second fluid flow path from at least one of the hydraulically actuated components and to synchronize the hydraulically actuated components.

This application claims the benefit of U.S. Provisional Application No. 60/974,355 filed Sep. 21, 2007, and the entire contents of which are hereby incorporated by reference.

The section headings used herein are for organizational purposes only and are not to be construed as limiting the subject matter described in any way.

### FIELD

Applicants' teachings relate to a system and apparatus to synchronize a plurality of hydraulically actuated components.

### INTRODUCTION

In hydraulic fluid distribution systems, synchronization is maintaining a plurality of hydraulically actuated components relative to each other. In various embodiments of applicants' teachings, synchronization is maintaining a plurality of hydraulically actuated components generally coplanar to one another. For example, but not limited to, in an automotive vehicle lift rack, a vehicle is driven onto a pair of platforms, which are then raised to allow a technician to access the vehicles undercarriage. The platforms are to be maintained in a level configuration at all times, not only when raised, but during raising and lowering of the platforms.

### SUMMARY

Applicants' teachings relate to a system and apparatus to synchronize a plurality of hydraulically actuated components. In various embodiments of applicants' teachings, for example, but not limited to, in an automotive vehicle lift rack, a system and apparatus is disclosed to synchronize the platforms of the lift so that they are maintained generally coplanar to one another, and in accordance with some embodiments of applicants' teachings, in a generally level configuration.

In accordance with various embodiments of applicants' teachings, a valve manifold for use with a hydraulic fluid control system is disclosed. The valve manifold comprises a source port, the source port adapted to be connected to a hydraulic fluid reservoir. Moreover, the valve manifold comprises a plurality of component ports in fluid communication with the source port. The plurality of component ports are adapted to be connected to respective hydraulically actuated components, such as, for example, but not limited to, an automotive vehicle lift rack.

In accordance with various embodiments of applicants' teachings, the valve manifold also comprises a return port in selective fluid communication with at least two of the component ports. The return port is adapted to be connected to a hydraulic fluid reservoir.

In accordance with various embodiments of applicants' teachings, the valve manifold comprises a discharge valve. The discharge valve is interposed between the return port and the at least two of the component ports, so that activation of the discharge valve allows at least a portion of the hydraulic fluid to flow away from at least one of the at least two component ports.

Moreover, in accordance with some embodiments of applicants' teachings, at least two discharge valves are provided. Each of the at least two discharge valves is interposed between the return port and one of the at least two component ports, so that activation of one or more of the discharge valves allows at least a portion of the hydraulic fluid to flow away from the respective one of the at least two component ports.

In accordance with some embodiments of applicants' teachings, the discharge valve meters the flow of at least a portion of the hydraulic fluid away from the component port and to the return port.

Further, in accordance with some embodiments of applicants' teachings, the discharge valve is a proportional valve selectable between at least two positions. The first position to stop fluid flow from the respective component port to the return port. The second position to allow at least a portion of the fluid to flow away from the respective component port and to the return port.

Moreover, in accordance with some embodiments of applicants' teachings, the valve manifold further comprises a fluid flow divider interposed between the source port and the at least two component ports. The valve manifold can further comprise a fluid flow combiner interposed between the at least two component ports and the source port. In some embodiments of applicants' teachings, the fluid flow divider and fluid flow combiner are a device that performs both functions, hereinafter referred to as a fluid flow divider and combiner.

In accordance with some embodiments of applicants' teachings, the discharge valve is interposed between the flow divider and combiner and the component ports.

Moreover, in accordance with some embodiments of applicants' teachings, the valve manifold further comprises a two-way valve. In accordance with some embodiments, each component port has a two-way valve associated with it. Further, in accordance with some embodiments of applicants' teachings, each two-way valve has a first position permitting fluid flow from the source port to the associated component port, and a second position permitting fluid flow from the associated component port to the source port.

In accordance with various embodiments of applicants' teachings, a hydraulic fluid control system to synchronize at least two hydraulically actuated components is disclosed. The system comprises a hydraulic fluid reservoir, and a plurality of hydraulically actuated components in fluid communication by a first fluid flow path with the hydraulic fluid reservoir. Moreover, in accordance with various embodiments of applicants' teachings, a discharge valve is provided, the discharge valve in selective fluid communication by a second fluid flow path with at least two of the hydraulically actuated components and a hydraulic fluid reservoir.

Moreover, in accordance with various embodiments of applicants' teachings, the system further comprises a control unit responsive to relative displacement of the at least two hydraulically actuated components. The control unit to selectively control the discharge valve, so that in response to the relative displacement of the at least two hydraulically actuated components the control unit activates the discharge valve to allow at least a portion of the hydraulic fluid to flow away by the second fluid flow path from at least one of the hydraulically actuated components to the hydraulic fluid reservoir and to synchronize the at least two hydraulically actuated components.

Further, in accordance with some embodiments of applicants' teachings, at least two discharge valves are provided, each of the at least two discharge valves in selective fluid communication by the second fluid flow path with the hydraulic fluid reservoir and a respective one of the at least two hydraulically actuated components.

In accordance with some embodiments of applicants' teachings, the control unit selectively controls the at least two discharge valves. Accordingly, in response to the relative displacement of the at least two hydraulically actuated components, the control unit activates one or more of the discharge valves to allow at least a portion of the hydraulic fluid to flow away by the second fluid flow path from the respective one of the hydraulically actuated components and to the hydraulic fluid reservoir, thereby synchronizing the at least two hydraulically actuated components.

In accordance with some embodiments of applicants' teachings, the discharge valve meters the flow of at least a portion of the hydraulic fluid away from the hydraulically actuated component and to the hydraulic fluid reservoir.

In accordance with some embodiments of applicants' teachings, the discharge valve is a proportional valve selectable between at least two positions. The first position to stop fluid flow from the respective hydraulically actuated component to the hydraulic fluid reservoir. The second position to allow at least a portion of the fluid to flow from the respective hydraulically actuated component to the hydraulic fluid reservoir.

Moreover, in accordance with some embodiments of applicants' teachings, the hydraulic fluid control system comprises a fluid flow divider in the first fluid flow path, the flow divider interposed between the hydraulic fluid reservoir and the at least two hydraulically actuated components. The hydraulic fluid control system can further comprise a fluid flow combiner interposed between the at least two hydraulically actuated components and the hydraulic fluid reservoir. In some embodiments of applicants' teachings, the fluid flow divider and fluid flow combiner are a device that performs both functions, hereinafter referred to as a fluid flow divider and combiner.

In accordance with some embodiments of applicants' teachings the discharge valve is interposed between the flow divider and combiner and the hydraulically actuated components, so that the discharge valve, when activated, allows at least a portion of the hydraulic fluid to flow by the second fluid flow path from the first flow path and to the hydraulic fluid reservoir.

In particular, and in accordance with some embodiments of applicants' teachings, the hydraulic fluid control system further comprises at least two two-way valves. Each two-way valve is interposed in the first flow path between a respective hydraulically actuated component and the fluid flow divider and combiner. Each two-way valve having a first position permitting fluid flow by the first flow path from the hydraulic fluid reservoir to the respective hydraulically actuated component, and a second position permitting fluid flow by the first flow path from the respective hydraulically actuated component to the hydraulic fluid reservoir.

Moreover, in accordance with various embodiments of applicants' teachings the hydraulic fluid control system further comprises at least two fluid velocity fuses interposed in the first flow path between a respective one of each of the hydraulically actuated component and the flow divider and combiner. In particular, and in accordance with some embodiments of applicants' teachings, the velocity fuses are interposed in the first flow path between a respective one of each of the hydraulically actuated component and the two-way valves.

Further, in accordance with some embodiments of applicants' teachings, the control unit comprises a sensor, for example, but not limited to, an inclinometer, to detect the relative displacement of the at least two hydraulically actuated components. For some embodiments, each of the at least two hydraulically actuated components can have a sensor.

In accordance with various embodiments of applicants' teachings, the at least two hydraulically actuated components are associated with lifts, such as, for example, but not limited to, an automotive vehicle lift rack. In accordance with some embodiments of applicants' teachings the relative displacement between the at least two hydraulically actuated components is variations in vertical elevation between the respective platforms of the lifts.

Moreover, in accordance with some embodiments of applicants' teachings, the hydraulic fluid control system further comprises devices, such as, for example, but not limited to, a light source. The light source can be connected to the control unit and responsive to various preprogrammed conditions, such as, for example, but not limited to, turning on or off depending on the height of the lifts relative to some predetermined threshold.

Further, in accordance with various embodiments of applicants' teachings, a method to synchronize at least two hydraulically actuated components is disclosed. The method comprises, in response to a command to displace at least two hydraulically actuated components, allowing hydraulic fluid to flow by a first fluid flow path between a hydraulic fluid reservoir and the hydraulically actuated components, determining relative displacement of the at least two hydraulically actuated components, and, in response to the relative displacement determined, selectively allowing at least a portion of the hydraulic fluid to flow away by a second fluid flow path from one or more of the hydraulically actuated components and to a hydraulic fluid reservoir, and thereby synchronizing the at least two hydraulically actuated components. In accordance with various embodiments of applicants' teachings, the second flow path can be connected at one end to the first flow path, but is otherwise separate from the first flow path.

Moreover, in accordance with some embodiments of the method of applicants' teachings, a discharge valve selectively allows at least a portion of the hydraulic fluid to flow away by the second fluid flow path from one or more of the hydraulically actuated components and to the hydraulic fluid reservoir.

In accordance with some embodiments of the method of applicants' teachings the discharge valve meters the flow of hydraulic fluid.

Further, in accordance with some embodiments of the method of applicants' teachings, the discharge valve is a proportional valve selectable between at least two positions, the first position to stop fluid flow from the respective hydraulically actuated components to the hydraulic fluid reservoir, and the second position to allow at least a portion of fluid to flow from the respective hydraulically actuated components to the hydraulic fluid reservoir.

Further, in accordance with some embodiments of the method of applicants' teachings the first fluid flow path comprises a fluid flow divider. The flow divider is interposed between the hydraulic fluid reservoir and the at least two hydraulically actuated components. Moreover, the method can further comprise a fluid flow combiner interposed between the at least two hydraulically actuated component ports and the hydraulic fluid reservoir. In some embodiments of applicants' teachings, the fluid flow divider and fluid flow combiner are a device that performs both functions, hereinafter referred to as a fluid flow divider and combiner.

Moreover, in accordance with some embodiments of applicants' teachings the second fluid flow path is interposed between the flow divider and combiner and the respective one of the at least two hydraulically actuated components.

In accordance with some embodiments of the method of applicants' teachings, displacement of the at least two hydraulically actuated components, is controlled, in part, by at least two two-way valves. Each two-way valve is interposed in the first flow path between a respective hydraulically actuated component and the fluid flow divider and combiner.

In accordance with some embodiments of the method of applicant's teachings, a sensor, such as, for example, but not limited to, an inclinometer determines relative displacement of the at least two hydraulically actuated components. Moreover, the at least two hydraulically actuated components can each have a sensor.

Further, in accordance with various embodiments of the method of applicants' teachings, the at least two hydraulically actuated components is associated with lifts, such as, for example, but not limited to, an automotive vehicle lift rack. In accordance with some embodiments of applicants' teachings the relative displacement between the at least two hydraulically actuated components is variations in vertical elevation between the platforms of the respective lifts.

Moreover, in accordance with some embodiments of the method of applicants' teachings, determining the relative displacement between the at least two hydraulically actuated components comprises a control unit. Further, the control unit, in response to various preprogrammed conditions, can activate user devices or accessories. For example, but not limited to, the user devices can comprise a light that is activated upon the hydraulically actuated components reaching a preset threshold, such as, for example, but not limited to, a set height above ground level, as in the case of a automotive vehicle lift rack.

Further, in accordance with some embodiments of the method of applicants' teachings, when the relative displacement between the at least two hydraulically actuated components is about zero, the position of the at least two hydraulically actuated components can be stored. For example, but not limited to, the position of the at least two hydraulically actuated components can be stored in the control unit.

Moreover, in accordance with some embodiments of applicants' teachings the method comprises the step of storing the upper and lower limits of the hydraulically actuated components.

Further, according to applicants' teachings, the method further comprises selectively allowing hydraulic fluid to be pumped through the second flow path to one or more of the hydraulically actuated components to synchronize the at least two hydraulically actuated components.

These and other features of the applicant's teachings are set forth herein.

### DRAWINGS

The skilled person in the art will understand that the drawings, described below, are for illustration purposes only. The drawings are not intended to limit the scope of the applicant's teachings in any way.

FIG. 1 is a perspective view of a valve manifold;

FIG. 2 is a schematic pressure fluid diagram; and

FIGS. 3 to 7 are flow charts of various examples of the programmable logic valve control.

### DESCRIPTION OF VARIOUS EMBODIMENTS

Applicants' teachings relate to a system and apparatus to synchronize a plurality of hydraulically actuated components. In various embodiments of applicants' teachings, for example, but not limited to, in an automotive vehicle lift rack, a system and apparatus are disclosed to synchronize the platforms of the lift so that they are maintained generally coplanar to one another, and in accordance with some embodiments of applicants' teachings, in a generally level configuration.

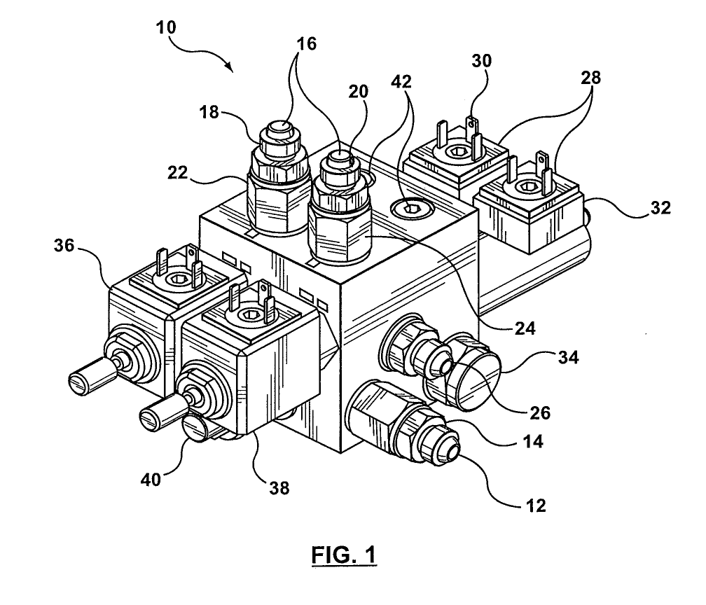

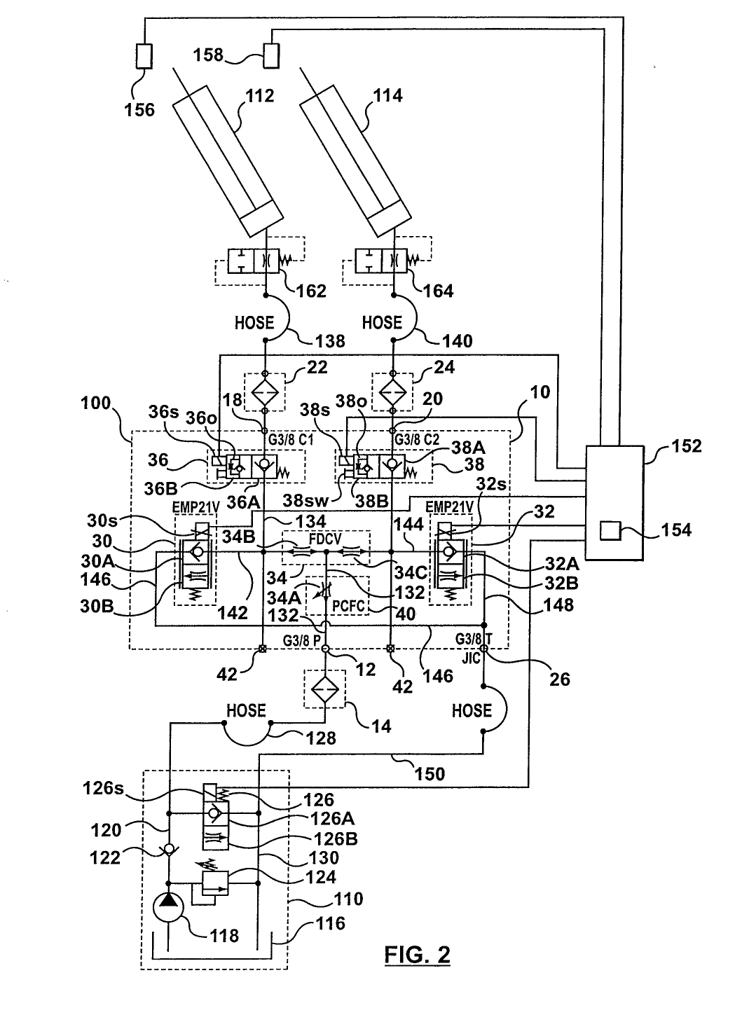

In accordance with various embodiments of applicants' teachings, and as illustrated in FIG. 1, a valve manifold 10 for use with a hydraulic fluid control system (see FIG. 2) is disclosed. The valve manifold comprises a source port 12. The source port 12 is adapted to be connected to a hydraulic fluid reservoir (not shown in FIG. 1). Source port 12 can also include a filter assembly 14.

Moreover, the valve manifold 10 comprises a plurality of component ports 16 in fluid communication through first internal fluid paths (not shown in FIG. 1, but shown in schematic in FIG. 2, as will hereinafter be explained) with the source port 12. The component ports 16 are adapted to be connected to respective hydraulically actuated components (not shown), such as, for example, but not limited to, an automotive vehicle lift rack. For purposes of the various embodiments of applicants' teachings as disclosed in FIG. 1, two component ports are shown, namely, component port 18 and component port 20. It can be appreciated, however, that applicants' teachings are not intended to be limited to only two component ports. The component ports can also include a filter assembly, such as, for example filter assembly 22 and 24, for component ports 18 and 20, respectively.

In accordance with various embodiments of applicants' teachings, the valve manifold 10 also comprises a return port 26 in selective fluid communication through second internal fluid paths (not shown in FIG. 1, but shown in schematic in FIG. 2, as will hereinafter be explained) with the component ports 18 and 20. The return port 26 is adapted to be connected to a hydraulic fluid reservoir.

In accordance with various embodiments of applicants' teachings, the valve manifold 10 comprises a discharge valve 28. The discharge valve 28 is interposed between the return port 26 and the component ports 18 and 20. Activation of the discharge valve 28 allows at least a portion of the hydraulic fluid to flow away from at least one of the at least two component ports 18 and 20, as will hereinafter be explained.

Moreover, in accordance with some embodiments of applicants' teachings, at least two discharge valves 30, 32 are provided. Each of the at least two discharge valves is interposed between the return port 26 and one of the at least two component ports 18 and 20, respectively, as will hereinafter be explained in greater detail, particularly having regard to FIG. 2. Activation of one or more of the discharge valves 30, 32 allows at least a portion of the hydraulic fluid to flow away from the respective one of the at least two component ports 18 and 20.

The discharge valves 30, 32 can meter the flow of at least a portion of the hydraulic fluid away from the respective component ports 18 and 20 and to the return port 26, all as will hereinafter be explained in greater detail.

In accordance with some embodiments of applicants' teachings, the discharge valves 30, 32 can be proportional valves selectable between at least two positions. The first position to stop fluid flow from the respective component port 18 and 20 and to the return port 26. The second position to allow at least a portion of the fluid to flow away from the respective component port 18 and 20 and to the return port 26.

The valve manifold 10 can further include a fluid flow divider. The fluid flow divider is interposed in the first fluid flow paths between the source port 12 and the component ports 18 and 20. The valve manifold can further comprise a fluid flow combiner interposed between the at least two component ports 18 and 20 and the source port 12. In some embodiments of applicants' teachings, the fluid flow divider and fluid flow combiner are a device that performs both functions, hereinafter referred to as a fluid flow divider and combiner, and shown as flow divider and combiner 34 in FIG. 1 for some of the embodiments of applicants' teachings.

Moreover, in accordance with some embodiments of applicants' teachings, the valve manifold 10 can further include a two-way valve, such as, for example, but not limited to two two-way valves 36 and 38 as illustrated in FIG. 1. In accordance with some embodiments, each component port 18 and 20 has a two-way valve 36, 38, respectively, associated with it. Each two-way valve 36, 38 has a first position permitting fluid flow from the source port 12 to the associated component port 18, 20, respectively, and a second position permitting fluid flow from the associated component port 18, 20 to the source port 12, all as will hereinafter be explained.

Also, in accordance with some embodiments of applicants' teachings, the valve manifold can include a flow control valve 40, such as, for example, but not limited to, a pressure controlled adjustable orifice, associated with the source port 12. The flow control valve 40 can be, for example, but not limited to, a needle valve.

Further, where applicable, valve manifold 10 can include stops 42. Stops 42 act as plugs to close off any unused fluid flow paths in the valve manifold.

The interconnection of the various components described above and the fluid flow paths referred to will now be explained in greater detail having regard to FIG. 2, which is a schematic pressure fluid diagram showing the organization of the components in the fluid control system 100 of applicants' teachings. Common elements in the valve manifold 10 between FIGS. 1 and 2 use the same reference characters for clarity. Also, for clarity, the schematic illustrated in FIG. 2 is for a system that allows fluid flow between two hydraulically actuated components and a hydraulic fluid reservoir and a reservoir of hydraulic fluid. It can be appreciated, however, that configurations able to support a plurality of hydraulically actuated components is contemplated and applicants' teachings is not to be limited to only the configuration shown in FIG. 2.

The fluid control system 100 comprises a valve manifold 10, a power unit manifold 110, and hydraulically actuated components 112, 114, such as, for example, but not limited to, left lifting cylinder and right lifting cylinder. The lifting cylinders can be connected to, for example, but not limited to, an automotive vehicle lift system (not shown) so as to vertically elevate vehicle support runways or support members (not shown) to provide access to the underside of an automotive vehicle for service thereof. Although FIG. 2 illustrates two hydraulically actuated components, applicants' teaching are not intended to be limited to just two hydraulically actuated components.

The valve manifold 10, power unit manifold 110, and hydraulically actuated components 112, 114, can be interconnected by miscellaneous fluid lines and hoses in fluid communication to form a fluid circuit. In some embodiments of applicants' teachings, the hydraulic fluid control system 100 uses a hydraulic fluid (not shown), but it can be appreciated that alternative fluids having the necessary compression and flow characteristics can be employed.

The power unit manifold 110 is located upstream from a hydraulic fluid reservoir, such as, for example, hydraulic fluid reservoir 116. Hydraulic fluid can be drawn from the reservoir 116 by a pump 118 driven by an electric motor (not shown), which together, for purposes of some embodiments of applicants' teachings, form the hydraulic fluid reservoir. The power unit manifold 110 can include on a fluid line 120, a reverse flow check valve 122, a pressure relief valve 124 interconnected to the fluid line 120 downstream of the reverse flow check valve 122, and a two-way flow return valve 126 located upstream of the reverse flow check valve 122.

For purposes of illustration, during a pressurized operation of the control system 100, such as, for example, during a lifting cycle, hydraulic fluid is withdrawn from the reservoir 116 by pump 118. The hydraulic fluid passes through the reverse flow check valve 122 and into the valve manifold 10 through line fluid 128, and eventually to the hydraulically actuated components 112, 114, as will hereinafter be explained. The reverse flow check valve 122 prevents the hydraulic fluid from returning to the pump 118 in the reverse direction.

In the event pressure is detected in the hydraulic fluid control system 100 that exceeds a preset pressure relief setting, the pressure relief valve 124 opens, diverting a portion of the hydraulic fluid flow from the fluid line 120 and back to the reservoir 116 along a return fluid line 130.

For purposes of illustration, during a de-pressurization operation of the control system 100, such as, for example, during a lowering cycle, hydraulic fluid is withdrawn from the hydraulically actuated components 112, 114 and returns to the fluid reservoir 116 after passing through the valve manifold 10, as will hereinafter be explained. The fluid leaves the valve manifold 10 and passes through fluid line 128 and through the two-way flow return valve 126 to return line 130. The returning fluid is prevented from returning to the reservoir 116 through the pump 118 by the reverse flow check valve 122 on the line 120.

Two-way flow return valve 126 can have two positions, a reverse flow restricted position (marked as 126-A) that is generally used for the pressurization operation, and an opened position (marked as 126-B) that is generally used for the de-pressurization operation. The open position can operate to meter the fluid flow, as desired. The two-way return valve 126 can switch between these two positions by actuation of a solenoid 126-S.

Valve manifold 10 will now be described in more detail having regard to its schematic representation in FIG. 2 as part of fluid control system 100. The fluid control system can comprise a first fluid flow path between the fluid reservoir 116 and the hydraulically actuated components 112, 114. For the various embodiments of applicants' teachings represented by the example of the schematic of FIG. 2, the first fluid path comprises: fluid line 128 between the power manifold 110 and the valve manifold 10; fluid line 132 between the source port 12 of valve manifold 10 and the fluid flow divider and combiner 34; fluid lines 134, 136 between the fluid flow divider and combiner 34 and component ports 18, 20, respectively, and fluid lines 138, 140, between the component ports 18, 20 and hydraulically actuated components 112, 114, respectively.

In accordance with various embodiments of applicants' teachings, a discharge valve is provided in selective fluid communication by a second fluid flow path with the fluid reservoir and the hydraulically actuated components 112, 114. For the example of the schematic of FIG. 2, the second fluid flow path comprises: fluid lines 142, 144 between fluid lines 134, 136 and discharge valves 30, 32, respectively; fluid lines 146, 148, between discharge valves 30, 32 and the fluid line 150; and fluid line 150 connecting fluid lines 146, 148 to the return fluid line 130 of the power manifold 110.

The fluid control system 100 can further comprise, according to various embodiments of applicants' teachings, a control unit 152 responsive to relative displacement of the at least two hydraulically actuated components. The control unit can comprise sensors, for example, but not limited to, an inclinometer connected to the hydraulically actuated components and to, for example, but not limited to, a processor 154 of the control unit. For the schematic as illustrated in FIG. 2, two sensors 156, 158 are provided to detect the relative displacement of the at least two hydraulically actuated components 112, 114, respectively. For example, where the two hydraulically actuated components are lifts, such as, for example, but not limited to, an automotive vehicle lift rack, the sensors 156, 158 detect the relative displacement between the at least two hydraulically actuated components 112, 114, namely, the vertical elevation difference between the platforms or runways of the respective lifts.

In accordance with some embodiments of applicants' teachings, the hydraulic fluid control system can include devices, such as, for example, a light (not shown). The light can be connected to the control unit 152 so that it is activated in responsive to various preprogrammed conditions, such as, for example, but not limited to, the height of the lifts above ground relative to some predetermined threshold. Other examples can include the vertical elevation difference between the respective lifts greater than a predetermined threshold indicating an unsafe condition. It can be appreciated more than one device or accessory, as well as devices or accessories other than a light source are contemplated by applicants' teachings.

According to some embodiments of applicants' teachings as illustrated in FIG. 2, the control unit 152 is connected to the discharge valves 30, 32 so that it can control the discharge valves 30, 32 in response to the relative displacement of the hydraulically actuated components 112, 114. In particular, the control unit 152 activates one or both of the discharge valves 30, 32 to allow at least a portion of the hydraulic fluid to flow away by the second fluid flow path from at least one or both of the hydraulically actuated components 112, 114 and to the fluid reservoir 116. As will hereinafter be explained, this allows the discharge valves 30, 32 to synchronize the hydraulically actuated components 112, 114.

As previously mentioned in relation to FIG. 1, the discharge valves 30, 32 can be, for example, but not limited to, proportional valves selectable between at least two positions. The first position 30-A, 32-A, respectively, stops fluid flow from the respective hydraulically actuated component 112, 114 to the fluid reservoir 116. The second position 30-B, 32-B, respectively, allows at least a portion of the fluid to flow away from the respective hydraulically actuated components 112, 114 and to the fluid reservoir. The second position can operate to meter the fluid flow, as desired. The discharge valves 30, 32 can switch between these two positions by actuation of a solenoid 30-S, 32-S, respectively.

The hydraulic fluid control system 100 can comprise a fluid flow divider and combiner 34 in the first fluid flow path, the flow divider and combiner is in the valve manifold 10 and interposed between the fluid reservoir 116 and the hydraulically actuated components 112, 114. In particular, as shown in the example illustrated in FIG. 2, the fluid flow divider and combiner 34 is connected to fluid line 132 and fluid lines 134, 136 of the first fluid flow path as follows: fluid line 132 is connected to port 34-A of fluid flow divider and combiner 34, and fluid lines 134, 136 are connected to ports 34-B, 34-C, respectively, of fluid flow divider and combiner 34.

In accordance with some embodiments of applicants' teachings the two discharge valves 30, 32 are interposed between the flow divider and combiner 34 and the respective one of the hydraulically actuated components 112, 114. Accordingly, when one or both of the discharge valves 30, 32 are activated, at least a portion of the hydraulic fluid flow from the respective hydraulically actuated component 112, 114 flows through fluid lines 134, 136 in the first flow path, and is then extracted or bleeds off through fluid lines 142, 144 to the discharge valves 30, 32, respectively. The fluid then flows to the fluid reservoir through the second flow path, namely, through fluid lines 146, 148, respectively, to fluid line 150, then to power manifold 110 and to the fluid reservoir through fluid line 130.

In accordance with some embodiments of applicants' teachings as illustrated in FIG. 2, the hydraulic fluid control system 100 can include two-way valves 36, 38 in the valve manifold 10. Each two-way valve 36, 38 is interposed in the first flow path on fluid lines 134, 136, respectively, and between respective hydraulically actuated component 112, 114 and the fluid flow divider and combiner 34. As previously mentioned in relation to FIG. 1, each two-way valve 36, 38 has a first position 36-A, 36-A, respectively, permitting fluid flow by the first flow path from the hydraulic fluid reservoir to the respective hydraulically actuated component 112, 114, and a second position 36-B, 38-B, respectively, permitting fluid flow by the first flow path from the respective hydraulically actuated component 112, 114 to the fluid reservoir 116. The two-way valves 36, 38 can switch between these two positions by actuation of a solenoid 36-S, 38-S, respectively.

In accordance with some embodiments of applicants' teachings, two-way valves 36, 38 can include a manual override 36-O, 38-O, respectively, that can be can be accessed by manually activating switch 36-SW, 38-SW. Activating the manual override permits metered fluid flow by the first flow path from the respective hydraulically actuated component 112, 114 to the fluid reservoir 116 in the event of, for example, a power failure.

Moreover, in accordance with various embodiments of applicants' teachings the hydraulic fluid control system 100 can include fluid velocity fuses 162, 164 interposed in the first flow path between respective hydraulically actuated components 112, 114 and the flow divider and combiner 34. In particular, and in accordance with some embodiments of applicants' teachings, the velocity fuses 162, 164 are interposed in the first flow path in fluid lines 138, 140, respectively, between hydraulically actuated components 112, 114 and the two-way valves 36, 38, respectively.

The velocity fuses 162, 164 meter the rate of fluid flow exiting the hydraulically actuated components 112, 114, respectively. If the flow rate exceeds a predetermined threshold, for example, but not limited to, due to a ruptured hose, the velocity fuses 162, 164 completely shut off all fluid exiting the hydraulically actuated components 112, 114, respectively, thereby locking the hydraulically actuated components in a safe condition.

For purposes of illustration, the operation of the fluid control system 100 during the pressurization and depressurizing cycles of the power unit manifold 110 will now be discussed having regard to the above description and the schematic of FIG. 2.

When the hydraulic fluid control system 100 is actuated to pressurize the hydraulically actuated components 112, 114, for example, but not limited to, providing lift to left and right hydraulic lifting cylinders of a vehicle lift, pressurized hydraulic fluid exits the power unit manifold 110 and travels through the fluid line 128 to the valve manifold 10.

In accordance with various embodiments of applicants' teachings, upon entering the valve manifold 10, the fluid can pass through a filter 14 and into the valve manifold 10 through the source port 12. Upon entering the valve manifold 10, the fluid can pass through a flow control valve 40, such as, for example, but not limited to, a pressure control needle valve. The fluid exits the flow control valve 40 and enters the flow divider and combiner 34 through port 34-A, where the fluid flow is split generally equally to each of ports 34-B and 34-C.

The fluid then exits the flow divider and combiner 34 through the ports 34-B, 34-C and enters fluid lines 134, 136, respectively, to pass through the two-way valves 36, 38, respectively, to exit the valve manifold 10 through the component ports 18, 20, respectively. The fluid then passes through the filters 22, 24, respectively, to fluid lines 138, 140, respectively, to then pass through velocity fuses 162, 164, respectively, and then enters, for purposes of the example illustrated, the hydraulically actuated components 112, 114, respectively.

It can be appreciated in the above discussion that due to proportioning inaccuracy of the flow divider and combiner 34, the flow of hydraulic fluid under pressure may not be split in equal ratios to the ports 34-B and 34-C, respectively. This can cause an unequal amount of hydraulic fluid to be diverted to either of the hydraulically actuated components 112, 114, which, in turn, can cause one of the hydraulically actuated components 112, 114 to expand at a rate different from the other, resulting in, for the example of hydraulic lifts, an uneven ascension of the platforms or automotive lift runways. This condition can be further exaggerated if the automotive lift runways are not carrying an equal load.

To compensate for unequal flow distribution of hydraulic fluid during a pressurization or lifting cycle, a small amount of hydraulic fluid is extracted from one or both of fluid lines 134, 136 by discharge valves 30, 32, respectively. The fluid is routed through the second flow path to the fluid reservoir 116. For example, if the sensor 156 detects that the platform of the lift on the left (i.e., of hydraulically actuated component 112) is higher than the platform of the lift on the right, then control unit 152 can activate solenoid 30-S of discharge valve 30 to switch discharge valve 30 to position 30-B, thereby allowing fluid to flow from fluid line 134 through fluid line 142 to fluid line 146. The fluid then exits valve manifold 10 by return port 26, whereby the fluid returns to fluid reservoir 116 through fluid line 150 and return line 130 in the power manifold 110. By extracting fluid from the fluid line 134, the platform of the lift of hydraulically actuating component 112 will raise at a lesser rate than the platform of the lift of hydraulically actuating component 114, allowing the platform of the lift of component 114 to catch up.

Similarly, if the sensor 158 detects that the platform of the lift on the right (i.e., of hydraulically actuated component 114) is higher than the platform of the lift on the right, then control unit 152 can activate solenoid 32-S of discharge valve 32 to switch discharge valve 32 to position 32-B, thereby allowing fluid to flow from fluid line 136 through fluid line 144 to fluid line 148. The fluid then exits valve manifold 10 by return port 26, whereby the fluid returns to fluid reservoir 116 through fluid line 150 and return line 130 in the power manifold 110. By extracting fluid from the fluid line 136, the platform of the lift of hydraulically actuating component 114 will raise at a lesser rate than the platform of the lift of hydraulically actuating component 112, allowing the platform of the lift of component 112 to catch up.

It can be appreciated that although individual operation of the discharge valves has been disclosed, for clarity, that it is possible for both discharge valves 30, 32, to operate at the same time, and also that the flow rate through the discharge valves 30, 32 can be different due to differences in the metered flow through the second positions 30-B, 32-B, respectively.

Accordingly, the discharge valves 30, 32 can be operated to synchronize the hydraulically actuated components 112, 114 during pressurization.

The CPU 154 of the control unit 152 can also be configured to detect whenever a vertical height variation exists between, for example, but not limited to, the platforms or runways of an automobile lift. Upon detecting a selected variation condition that represents a vertical elevation difference between the platforms or runways of the lifts, the CPU 154 can actuate one or both of discharge valves 30, 32 to divert a controlled portion of the fluid flow, as described above, to cause the leading platform or runway as detected by the sensors 156, 158, to lower in relation to the other platform or runway.

When depressurizing the hydraulically actuated components 112, 114, for example, but not limited to, lowering the left and right hydraulic lifting cylinders of a vehicle lift, the control unit 152 is activated to lower the hydraulically actuated components 112, 114. Control unit 152 activates solenoids 36-S, 38-S and 126-S, simultaneously, switching the positions of the two-way valves 36, 38 to 36-B, 38-B, respectively, and the position of the two-way return valve 126 to 126-B, allowing the fluid to flow generally to the free flow return positions. In the case of the hydraulically actuating components 112, 114 comprising lifts, the force of gravity acting on the mass of the platforms or runway lift structures supported by the hydraulic lifting cylinders will cause hydraulic fluid to exit the cylinders and ultimately to the fluid reservoir 116.

For the embodiments illustrated in FIG. 2, the return fluid flow passes through the velocity fuses 162, 164, respectively, through fluid lines 138, 140, respectively, into the valve manifold 10 by component ports 18, 20, respectively, through filters 22, 24, respectively. Once in valve manifold 10 the fluid then passes through the two-way valves 36, 38, respectively, then through fluid lines 134, 136, respectively, to fluid flow divider and combiner 34 through its ports 34-B, 34-C, respectively. Inside the fluid flow divider and combiner 34, the two hydraulic fluid flows are recombined into a single fluid flow in approximately equal ratios. The combined hydraulic fluid flow then exits the fluid flow divider and combiner 34 through port 34-A and to fluid control valve 40, whereupon the fluid exits valve manifold 10 through source port 12 and to fluid line 128. Once in fluid line 128, the fluid then passes to the power unit manifold 110, whereupon the fluid is diverted by the reverse flow check valve 122 in fluid line 120 to the two-way valve 126, which is now in position to allow the fluid to return to the fluid reservoir 116 by return line 130.

As with pressuring the hydraulically actuated components, the inaccurate nature of the flow divider and combiner 34 can cause the two separate hydraulic fluid streams exiting from each of the hydraulically actuated components to combine in inexact proportions. This unequal combination of the hydraulic fluid streams can cause, for the example of hydraulic lifts, an uneven descent of the platforms or lift runways. This condition can be further exaggerated if the platforms or lift runways are not carrying an equal load.

To compensate for unequal flow distribution of hydraulic fluid during a depressurization or lowering cycle, a small amount of hydraulic fluid is extracted from one or both of fluid lines 134, 136 by discharge valves 30, 32, respectively. The fluid is routed through the second flow path to the fluid reservoir 116. For example, if the sensor 156 detects that the platform of the lift on the left (i.e., of hydraulically actuated component 112) is higher than the platform of the lift on the right, then control unit 152 can activate solenoid 30-S of discharge valve 30 to switch discharge valve 30 to position 30-B, thereby allowing fluid to flow from fluid line 134 through fluid line 142 to fluid line 146. The fluid then exits valve manifold 10 by return port 26, whereby the fluid returns to fluid reservoir 116 through fluid line 150 and return line 130 in the power manifold 110. By extracting fluid from the fluid line 134, the platform of the lift of hydraulically actuating component 112 will lower at a quicker rate than the platform of the lift of hydraulically actuating component 114, allowing the platform of the lift of component 112 to catch up to the lower platform of the lift of component 114.

Similarly, if the sensor 158 detects that the platform of the lift on the right (i.e., of hydraulically actuated component 114) is higher than the platform of the lift on the left, then control unit 152 can activate solenoid 32-S of discharge valve 32 to switch discharge valve 32 to position 32-B, thereby allowing fluid to flow from fluid line 136 through fluid line 144 to fluid line 148. The fluid then exits valve manifold 10 by return port 26, whereby the fluid returns to fluid reservoir 116 through fluid line 150 and return line 130 in the power manifold 110. By extracting fluid from the fluid line 136, the platform of the lift of hydraulically actuating component 114 will lower at a quicker rate than the platform of the lift of hydraulically actuating component 112, allowing the platform of the lift of component 114 to catch up.

Again, individual operation of the discharge valves has been disclosed, for clarity, but it is possible for both discharge valves 30, 32, to operate at the same time, and also that the flow rate through the discharge valves 30, 32 can be different due to differences in the metered flow through the second positions 30-B, 32-B, respectively. Accordingly, the discharge valves 30, 32 can be operated to synchronize the hydraulically actuated components 112, 114 during depressurization.

Moreover, if the sensors detect that the platforms of the lift are in an unsafe condition, for example the height difference between the two platforms is unsafe, an emergency stop is triggered, stopping the pumps and returning the valves to a neutral position. The system can be used to level the platforms of the lift, which in a locked position cannot be lowered. In particular, the hydraulic pump motor 118 is started. Next, the appropriate proportional valve 30 or 32 corresponding to the platform to be raised is opened to a preset position. This will allow the hydraulic fluid to flow through the appropriate proportional valve 30, 32 to the corresponding hydraulic component 112, 114, thereby raising the corresponding platform or runway, while maintaining the other platform or runway in a stationary position. Once level, the system can operate normally as described above.

Aspects of the applicant's teachings may be further understood in light of the following examples, which should not be construed as limiting the scope of the present teachings in any way.

### Example

The control unit 152 can also carry out a number of functions, including, for example, but not limited to, pressurization of the hydraulically actuated components 112, 114 (for example, the raising of the platforms or runways of an automotive lift), depressurization of the hydraulically actuated components 112, 114 (for example, the lowering of the platforms or runways of an automotive lift), but also calibration of the lifts upon start-up, and a control override when, for example, the hydraulically actuated components 112, 114 have stopped all motion for example, but not limited to due to a hydraulic fluid leak or to synchronization errors detected outside of acceptable safety limits. These functions can best be understood by way of the following examples of the programmable logic valve control block diagrams. The following examples are illustrative of certain functions only, and are not meant to be limiting to applicants' teachings, nor to represent the only method of carry out applicants' teachings.

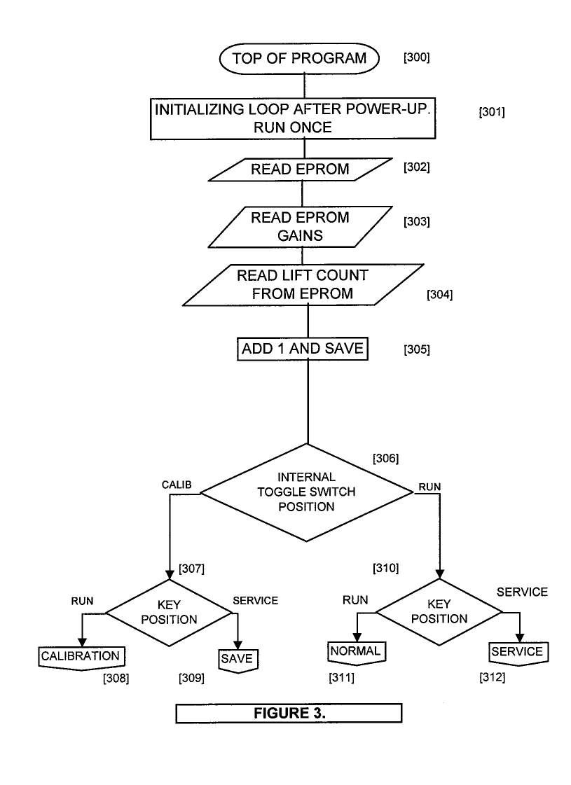

Referring to FIG. 3, step 300 represents the start of the program upon, for example, start-up, but also the point where the program cycles back to after completing the hereinafter-described steps. At this initial stage, the motor of the hydraulic pump is stopped and all valves are in the “start-up” position or neutral position.

After starting at step 300, the program then checks at step 301 to see if the program is being run the first time after a power up.

The program then proceeds to step 302, where initial set-up parameters are read from the control unit 152. Control unit 152 can be, for example, but not limited to, an EPROM chip containing the initial set-up parameters. The start-up parameters can include, for example, but not limited to: the height of the platforms or runways of the lift since the program was last run, settings for appropriate leveling of the platforms or runways of an automotive lift and the error range limits. The level settings can be factory default settings, or user defined settings, as will hereinafter be explained. For the illustrative example of applicants' teachings, the possible positioning errors between the two actuated components have been grouped in three ranges, namely:
Range 1: acceptable errors, within the coplanar tolerance for the two platforms or runways;
Range 2: unacceptable errors, that require corrective action, in order to be brought into Range 1; and
Range 3: excessive position errors, or difference between the platforms or runways, which make the lift unsafe to operate.

After reading the start-up parameters in step 302, the program then proceeds to step 303. In step 303 the program reads the settings, or gains, of the valves of the fluid control system 100, for example, but not limited to, the position of the discharge valves 30, 32, which in normal operation, and for start-up, should be in position 30-A, 32-A, respectively.

After reading the gains, the program then proceeds to step 304. The program adds a one (1) count to the lift height parameters from step 304 in step 305, and re-saves the value in the EPROM chip. This enables the system to keep track of the number of cycles run, which can be useful, for example, but not limited to, warranty issues.

The program then proceeds to step 306, where it can be switched to two different modes, namely, for example, but not limited to, “Calibration” and “Run”, as will be explained in greater detail below. This is achieved, for example, but not limited to, by the means of a two-position switch, located, for the illustrative example of an automotive lift, inside the operator's console, and accessible only to service technicians.

The program then checks, in steps 307, 310, respectively, the position of, for the illustrative example of an automotive lift, a two-position key located on the lift operator's console. Based on the two possible positions of the internal switch and the two positions of the key, a total of four modes of operation can be achieved, namely: “Calibration” 308 and “Save” 309 (for the two positions of the key when the internal switch is set to the “Calibration” mode), and “Normal” 311 and “Service” 312 (for the two positions of the key when the internal switch is set to the “Run” mode). The four modes of operation will be explained in greater detail below.

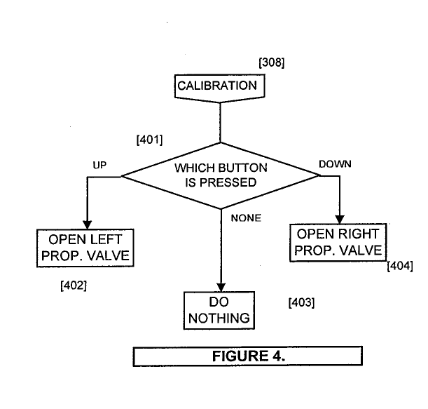

Referring now to FIG. 4, the “Calibration” mode 308 of operation will be explained. This mode of operation allows, for the illustrative example of an automotive lift, the fine-tuning of the platform or runway heights. The hydraulic pump motor remains stopped in this mode. “Calibration” mode 308 is activated if the key position in step 307 of FIG. 3 is in the “Run” position, and the internal toggle switch is in the “Calibration” position.

The program proceeds to step 401, where it checks the status of “Up” and “Down” buttons that are present on the operator console. If the button being pressed in step 401 is the “Up” button, then the control unit 152 switches the control valve 30 to position 30-B, to a preset opening value, in step 402. For the illustrative example of an automotive lift, this will allow lowering of the left platform or runway of the lift.

If the button being pressed in step 401 is the “Down” button, then the control unit 152 switches the control valve 32 to position 32-B, to a preset opening value, in step 404. For the illustrative example of an automotive lift, this will allow lowering of the right platform or runway of the lift.

If no button is being pressed in step 402 then the control unit 152 takes no action; step 403.

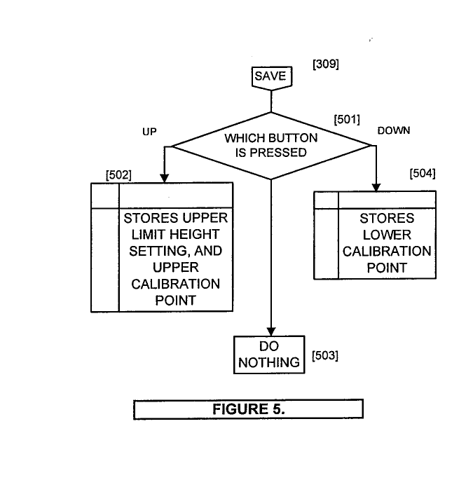

In FIG. 5, the “Save” mode 309 of operation is explained. In this mode, the values of the limit heights of the platforms of the lift and the calibration points of the sensors can be saved into the EPROM of the control unit 152. This also allows for the compensation of possible slight differences between the linearity of the two sensors. Referring to FIG. 3, if the operator console key activates the “Service” position in step 307, the program is then switched to the “Save” mode 309 of operation, and is ready to proceed to step 501 in FIG. 5.

The program will check in step 501 the status of the “Up” and “Down” buttons on the operator console. If none of the buttons are pressed, the program will not execute any action, as shown in step 503.

If the “Up” button is pressed, the program performs step 502, saving into EPROM the values of the upper limit height setting of the platforms of the lifts, and the upper calibration point of the sensors.

If the “Down” button is pressed, the program performs step 504, saving into EPROM the value of the lower calibration point of the sensors.

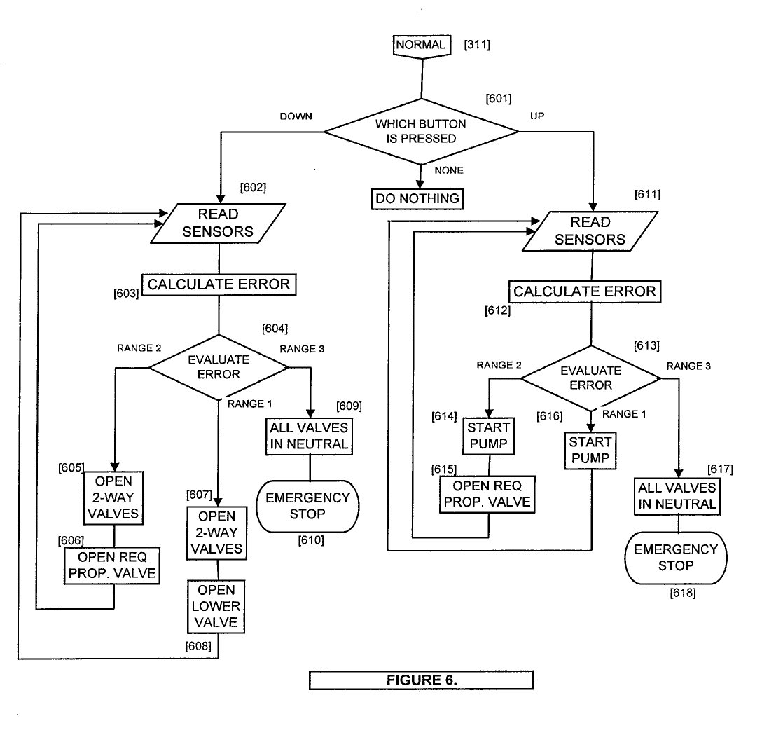

If the two-position switch in step 306 was set to its “Run” position and the key on the operator console in step 311 was set to its “Run” position, the program will work in the “Normal” mode 311 of operation. The “Normal” mode 311 of operation flow chart is shown in FIG. 6.

In step 601, the program checks the status of the “Up” and “Down” buttons on the operator console. If the “Down” button was pressed in step 601, the program advances to step 602 and reads by the use of sensors 156 and 158 the positions of the hydraulically actuated components 112 and 114, respectively.

The program then performs, in step 603, the calculation of the position error, as the difference between the height of the two platforms or runways of the lift, and evaluates this error in step 604, using error range limit values read at step 302. If the calculated error is within Range 1, the platforms or runways of the lift are considered acceptably coplanar and no correction is necessary. The program will command the opening of both two-way valves 36, 38 in step 607, and the opening of the lower valve 126 in step 608. The program will then cycle back to step 602, to continue monitoring the positioning error.

If the error evaluated in step 604 is in Range 2, the two platforms or runways are considered functional, but out of acceptable levelness, and corrective action is required. The program advances to step 605, opening the two-way valves 36 and 38, to allow lowering of the actuated components, then proceeds to step 606. In step 606, the control unit 152 commands the opening of one or two of the proportional valves 30, 32. The valve 30, 32 corresponding to the actuated component that lags behind during lowering operation is opened more, or in some embodiments, solely. This will cause the component that lagged behind to retract faster, and catch up with the other one.

The program will then cycle back to step 602, to continue monitoring the positioning error.

If the error evaluated in step 604 is in Range 3, the height difference between the two platforms or runways is excessive, and the lift is considered unsafe to operate. The program will advance to step 609. In step 609, the program ensures that all valves are reset to the neutral position, triggers an emergency stop and alerts the operator.

If the “Up” button was pressed in step 601, the program advances to step 611 and reads the positions of the actuated components, 112 and 114 by the use of sensors 156 and 158, respectively.

The program then performs, in step 612, the calculation of the position error, as the difference between the height of the two platforms or runways and evaluates this error in step 613, using error range limit values read at step 302 if FIG. 3.

If the calculated error is within Range 1, the platforms or runways are considered acceptably coplanar and no correction is necessary. The program will maintain all valves in the neutral position and trigger the start of the hydraulic pump motor, to start rising the two lift platforms or runways. The program will then cycle back to step 602, to continue monitoring the positioning error.

If the error evaluated in step 613 is in Range 2, the two platforms or runways are considered functional, but out of acceptable levelness. The program advances to step 614, starting the hydraulic pump motor, allowing the hydraulically actuated components to rise. The program then proceeds to step 615. In step 615, the control unit 152 commands the opening of one or two of the proportional valves 30, 32. Again, opening more, or in some examples solely, the valve 30, 32 that corresponds to the hydraulically actuated component that rises faster. This causes the faster rising platform to rise slower, allowing the component that lagged behind to catch up. The program will then cycle back to step 611, to continue monitoring the positioning error.

If the error evaluated in step 604 is in Range 3, the height difference between the two platforms or runways is excessive, and the lift is considered unsafe to operate. The program will advance to step 617. In step 617, the program ensures that all valves are reset to the neutral position, the hydraulic pump motor is stopped and triggers an emergency stop and alerts the operator.

If, at step 601, none of the “Up” and “Down” buttons on the operator console is pressed, the control unit 152 and the fluid control system 100 will take no action.

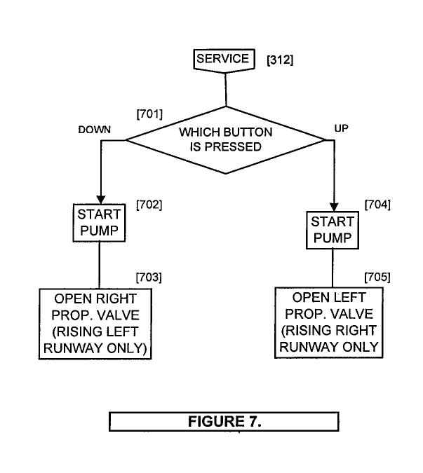

FIG. 7 shows the flow chart for the program in “Service” mode 312. This mode can be selected, for example, if the error is in Range 3, for example the height difference between the two platforms is unsafe and an emergency stop has been triggered. The Service mode 312 is selected if, at step 306, the internal toggle switch is set in its “Run” position and, at step 310 the key on the operator console is set to its “Service” position. The program is now ready to go to step 701.

If the “Down” button was pressed in step 701, the program advances to step 702 and starts the hydraulic pump motor. The program then executes step 703 and commands opening of the proportional valve 32 to a preset position. This will allow the left platform or runway to rise, while the right platform or runway is maintained stationary.

If the “Up” button was pressed in step 701, the program advances to step 704 and starts the hydraulic pump motor. Then, the program executes step 705 and commands opening of the proportional valve 30 to a preset position. This will allow the right platform or runway to rise, while the left platform or runway is maintained stationary.

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. A valve manifold for use with a hydraulic fluid control system, the valve manifold comprising:
a) a source port, the source port adapted to be connected to a hydraulic fluid reservoir;
b) a plurality of component ports in fluid communication with the source port, the plurality of component ports adapted to be connected to respective hydraulically actuated components;
c) a return port in selective fluid communication with at least two of the component ports, the return port adapted to be connected to a hydraulic fluid reservoir; and
d) a discharge valve, the discharge valve interposed between the return port and the at least two of the component ports, so that activation of the discharge valve allows at least a portion of the hydraulic fluid to flow away from at least one of the at least two component ports.

2-9. (canceled)

10. A hydraulic fluid control system to synchronize at least two hydraulically actuated components, the control system comprising:
a) a hydraulic fluid reservoir;
b) a plurality of hydraulically actuated components in fluid communication by a first fluid flow path with the hydraulic fluid reservoir;
c) a discharge valve, the discharge valve in selective fluid communication by a second fluid flow path with a hydraulic fluid reservoir and at least two of the hydraulically actuated components; and
d) a control unit responsive to relative displacement of the at least two hydraulically actuated components, the control unit to selectively control the discharge valve, so that in response to the relative displacement of the at least two hydraulically actuated components the control unit activates the discharge valve to allow at least a portion of the hydraulic fluid to flow away by the second fluid flow path from at least one of the hydraulically actuated components and to the hydraulic fluid reservoir and to synchronize the at least two hydraulically actuated components.

11-26. (canceled)

27. A method to synchronize at least two hydraulically actuated components, the method comprising:
a) in response to a command to displace at least two hydraulically actuated components, allowing hydraulic fluid to flow by a first fluid flow path between a hydraulic fluid reservoir and the hydraulically actuated components;
b) determining relative displacement of the at least two hydraulically actuated components; and
c) in response to the relative displacement determined, selectively allowing at least a portion of the hydraulic fluid to flow away by a second fluid flow path from one or more of the hydraulically actuated components and to a hydraulic fluid reservoir and to synchronize the at least two hydraulically actuated components.

28. A method according to claim 27, wherein a discharge valve selectively allows at least a portion of the hydraulic fluid to flow away by a second fluid flow path from one or more of the hydraulically actuated components and to the hydraulic fluid reservoir.

29. A method according to claim 28, wherein the discharge valve meters the flow of hydraulic fluid.

30. A method according to claim 28, wherein the discharge valve is a proportional valve selectable between at least two positions, the first position to stop fluid flow from the respective hydraulically actuated components to the hydraulic fluid reservoir, the second position to allow at least a portion of fluid to flow away from the respective hydraulically actuated components to the hydraulic fluid reservoir.

31. A method according to claim 27, wherein the first fluid flow path comprises a fluid flow divider, the flow divider interposed between the hydraulic fluid reservoir and the at least two hydraulically actuated components.

32. A method according to claim 31, wherein the second fluid flow path is interposed between the flow divider and the respective one of the at least two hydraulically actuated components.

33. A method according to claim 31, wherein the first fluid flow path further comprises a fluid flow combiner, the fluid flow combiner interposed between the at least two hydraulically actuated components and the hydraulic fluid reservoir.

34. A method according to claim 33, wherein the fluid flow divider and the fluid flow combiner are the same device.

35. A method according to claim 31, wherein displacement of the at least two hydraulically actuated components, is controlled, in part, by at least two two-way valves, each two-way valve interposed in the first flow path between a respective hydraulically actuated component and the fluid flow divider.

36. A method according to claim 27, wherein a sensor determines relative displacement of the at least two hydraulically actuated components.

37. A method according to claim 36, wherein each of the at least two hydraulically actuated components has a sensor.

38. A method according to claim 27, wherein the at least two hydraulically actuated components is associated with lifts.

39. A method according to claim 38, wherein the relative displacement between the at least two hydraulically actuated components is variations in vertical elevation between respective platforms of the lifts.

40. A method according to claim 27, wherein determining the relative displacement between the at least two hydraulically actuated components comprises a control unit.

41. A method according to claim 40, further comprising the step of the control unit, in response to various preprogrammed conditions, activating user devices.

42. A method according to claim 41, wherein the user devices can comprise a light that is activated upon reaching a preset threshold.

43. A method according to claim 27, further comprising the step of when the relative displacement between the at least two hydraulically actuated components is about zero, storing the position of the at least two hydraulically actuated components.

44. A method according to claim 27, further comprising the step of when the relative displacement between the at least two hydraulically actuated components is about zero, storing the position of the at least two hydraulically actuated components in the control unit.

45. A method according to claim 27, further comprising the step of storing the upper and lower limits of the hydraulically actuated components.

46. A method according to claim 27, further comprising selectively allowing hydraulic fluid to be pumped through the second flow path to one or more of the hydraulically actuated components to synchronize the at least two hydraulically actuated components.
